(19) United States
(12) Patent Application Publication
(10) Pub. No.: US 2008/0207791 A1
(43) Pub. Date: Aug. 28, 2008

(54) Process for producing polyurethane flexible foamed materials having low bulk density

(76) Inventors: Bert Klesczewski, Koln (DE); Manduela Otten, Leverkusen (DE); Bernd Dohmen, Monheim (DE)

Correspondence Address: BAYER MATERIAL SCIENCE LLC, 100 BAYER ROAD, PITTSBURGH, PA, 15205, US

(21) Appl. No.: 12/070,614

(22) Filed: Feb. 20, 2008

(30) Foreign Application Priority Data
Feb. 24, 2007 (DE) 10 2007 009 126.7

(51) Int. Cl. C08G 18/00

(52) U.S. Cl. 521/174

(57) ABSTRACT

Mechanically compressible polyurethane foamed materials with low bulk density are produced by reacting a polyol component satisfying specified compositional requirements with an isocyanate component that includes a modified toluene diisocyanate. The polyurethane foamed materials produced are useful as acoustic and thermal insulation.

### BACKGROUND OF THE INVENTION

The present invention relates to a process for producing mechanically compressible polyurethane foamed materials of low bulk density, to the polyurethane foamed materials themselves, and also to their use in acoustic and thermal insulation.

A great demand has existed for polyurethane foamed materials that are mechanically compressible and that exhibit a low bulk density for use as acoustic and thermal insulating materials. The expression “polyurethane foamed materials of low bulk density” means rigid, compressible polyurethane foamed materials that are suitable for thermal and/or acoustic insulation, that exhibit a bulk density of less than 25 kg/m³, and have a mechanical load-bearing capacity that is expressed in measured values for tensile strength of more than 20 kPa, and for elongation at break of more than 10%.

Foamed materials of this type are conventionally produced either continuously or discontinuously on the basis of various isocyanates such as the phosgenated condensation products of formaldehyde and aniline, the so-called MDI products. However, foamed materials which are produced from MDI products have low mechanical load-bearing capacity, which is reflected in values of less then 20 kPa for the tensile strength and less than 10% for elongation at break. This low mechanical load-bearing capacity has an unfavorable effect on their capacity for further processing.

### SUMMARY OF THE INVENTION

The object of the present invention is therefore to provide a process for the production of polyurethane foamed materials having bulk densities of less than 25 kg/m³ having improved mechanical properties.

This object is achieved by producing the polyurethane foams from formulations meeting the compositional requirements described more fully herein.

### DETAILED DESCRIPTION OF THE INVENTION

The present invention relates to a process for producing polyurethane foamed materials having a bulk density of less then 25 kg/m³ from
I) a polyol composition which includes:
   a) 30-100 wt. % (relative to the total weight of the polyol composition I) of a polyoxyalkylene polyether polyol with a nominal functionality of 2-4, with an average molar mass of 1500-6000, with a proportion of more than 35% of secondary hydroxyl terminal groups (relative to the total number of hydroxyl terminal groups of the polyalkylene polyether polyol),
   b) 0-50 wt. % (relative to the total weight of the polyol composition I) of a polyoxyalkylene polyether polyol with a nominal functionality of 2-3.5 and with an average molar mass of 400-1000,
   c) 0-50 wt. % (relative to the total weight of the polyol composition I) of a polyoxyalkylene polyether polyol with a nominal functionality of 4-8 and with an average molar mass of 300-1000, and
   d) 0-30 wt. % (relative to the total weight of the polyol composition I) of a polyester polyol with a hydroxyl value of 40-500,
II) polyisocyanate composition with an isocyanate content of from 31 to 43 wt. % (relative to the total quantity of the polyisocyanate composition) in a quantity corresponding to an NCO/OH index of 25-150 which includes:
   a) 20-100 wt. % (relative to the total weight of the polyisocyanate composition II) of a modified toluene diisocyanate with an NCO content amounting to less than 44 wt. % (relative to the modified toluene diisocyanate II)a)) and
   b) 0-80 wt. % (relative to the total weight of the polyisocyanate composition II) of an isocyanate from the group comprising the MDI products,
III) 6-40 parts by weight of water (relative to the total weight of the polyol composition I) and also
IV) optionally, a physical blowing agent,
V) a catalyst,
VI) a flameproofing agent,
VII) a stabilizer, and
VIII) optionally, further auxiliary substances and additives.

The process of the present invention is advantageous if the polyisocyanate composition II is used in an amount corresponding to an NCO/OH Index which lies within the range of from 35 to 120.

The process of this invention is advantageous if the polyisocyanate composition II that is used exhibits an isocyanate content amounting to 35-39 wt. %, relative to the entire polyisocyanate composition II.

The process of this invention is particularly advantageous if the polyisocyanate composition II that is used includes:
a) 50-100 wt. % (relative to the total weight of the polyisocyanate composition II) of a modified toluene diisocyanate with an NCO content of less than 44 wt. % (relative to the modified toluene diisocyanate II)a)), and
b) 0-50 wt. % (relative to the total weight of the polyisocyanate composition II) of an isocyanate from the group comprising the MDI products.

The process according to the invention is more advantageous if the polyisocyanate composition II that is used is composed of from 95 to 100 wt. % (relative to the total weight of the polyisocyanate composition II) of a modified toluene diisocyanate II)a)) having an NCO content of less than 44 wt. %.

The process of this invention is advantageous if the modified toluene diisocyanate that is used having an NCO content of less than 44 wt. % (relative to the modified toluene diisocyanate II)a)) is obtained by modification of a mixture of 65-100 wt. % (relative to the total weight of the toluene diisocyanate mixture) 2,4-toluene diisocyanate and 0-35 wt. % (relative to the total weight of the toluene diisocyanate mixture) 2,6-toluene diisocyanate with a material containing at least two groups that are reactive with isocyanates.

This invention further provides a polyurethane foamed material that can be obtained by the process according to the invention.

This invention further provides acoustic and/or thermal insulation produced from the polyurethane foamed material of the present invention.

The polyoxyalkylene polyether polyols I)a), I)b) and I)c) that are useful for the purpose of producing the polyol component I may, for example, be prepared by polyaddition of alkylene oxides onto polyfunctional initiator compounds in the presence of basic catalyst or double-metal-cyanide (DMC) catalyst. Preferred initiator compounds are water and also molecules with two to eight hydroxyl groups per molecule, such as triethanolamine, 1,2-ethanediol, 1,2-propanediol, 1,3-propanediol, diethylene glycol, dipropylene glycol, triethylene glycol, tripropylene glycol, 1,2-butanediol, 1,3-butanediol, 1,4-butanediol, 1,2-hexanediol, 1,4-hexanediol, 1,5-hexanediol, 1,6-hexanediol, glycerol, trimethylolpropane, 1,2-diaminoethane, pentaerythritol, mannitol, sorbitol and saccharose.

Preferred alkylene oxides useful for the production of the poly(oxyalkylene) polyols that are employed in accordance with the invention are oxirane, methyloxirane and ethyloxirane. These may be used on their own or in a mixture. When used in a mixture, it is possible to convert the alkylene oxides randomly or in blockwise manner, or both in succession. Further details are disclosed in Ullmanns Encyclopädie der industriellen Chemie, Volume A21, 1992, pages 670 f.

Preferred polyfunctional initiator compounds for the polyoxyalkylene polyether polyol I)a) are glycerin, 1,2-propylene glycol, dipropylene glycol, trimethylol-propane, as well as mixtures thereof. The preferred functionality of the polyoxyalkylene polyether polyol I)a) is from 2.5 to 3.0. The preferred molar mass of the polyoxyalkylene polyether polyol I)a) is from 2500 to 5000. The preferred quantity of methyloxirane, relative to the total quantity of alkylene oxide used, is from 80-100 wt. %.

Preferred polyfunctional initiator compounds for the polyoxyalkylene polyether polyol I)b) include: glycerin, 1,2-ethanediol, 1,2-propylene glycol, dipropylene glycol, trimethylolpropane, 1,2-diaminoethane, as well as mixtures thereof. The preferred functionality of the polyoxyalkylene polyether polyol I)b) is from 2.0-3.0. The preferred molar mass of the polyoxyalkylene polyether polyol I)b) is from 500 to 900.

Preferred polyfunctional initiator compounds for the polyoxyalkylene polyether polyol I)c) include: glycerin, 1,2-ethanediol, 1,2-propylene glycol, and dipropylene glycol. The preferred functionality of the polyoxyalkylene polyether polyol I)c) is from 4.0 to 6.0. The preferred molar mass of the polyoxyalkylene polyether polyol I)c) is from 350 to 900.

The polyester polyols I)d) that are useful in the polyol component I may, for example, be prepared from polycarboxylic acids and polyols. Polycarboxylic acids that are suitable include: succinic acid, glutaric acid and adipic acid, and mixtures of these acids or their anhydrides or their esters with monofunctional C₁-C₄ alcohols. Monofunctional alcohols that are preferably used to produce the esters of the aliphatic polycarboxylic acids include: methanol, ethanol, 1-propanol, isopropanol, 1-butanol, 2-butanol and tert. butanol. Particularly preferred polycarboxylic acids are succinic acid, glutaric acid and adipic acid. Adipic acid is most preferred.

Polyols suitable for preparing the polyester polyols I)d) include unbranched aliphatic diols with α,ω-terminal hydroxyl groups, which may optionally exhibit up to three ether groups, and polyols with a hydroxyl functionality of more than two. Preferred polyols are 1,2-ethylene glycol, 1,3-propylene glycol, 1,4-butylene glycol, 1,6-hexylene glycol, diethylene glycol, triethylene glycol and tetraethylene glycol. Diethylene glycol is particularly preferred. Preferred polyols with a hydroxyl functionality greater than two are 1,1,1-trimethylolpropane, pentaerythritol and glycerin.

The molar mass of the polyester polyols is controlled by choice of the deficit of carboxyl groups in comparison with hydroxyl groups. Polyether esters useful in the invention exhibit hydroxyl values from 40 mg KOH/g to 500 mg KOH/g. Hydroxyl values of from 50 mg KOH/g to 300 mg KOH/g are preferred.

Polyisocyanate composition II) includes one or more modified toluene diisocyanates, for example 2,4- and 2,6-toluene diisocyanate and also mixtures of these isomers (‘TDI’), optionally in mixture with one or more polyphenyl-polymethylene polyisocyanates such as those prepared by aniline-formaldehyde condensation and subsequent phosgenation (‘crude MDI’). Other polyisocyanates (‘modified polyisocyanates’) having carbodiimide groups, urethane groups, allophanate groups, isocyanurate groups, urea groups or biuret groups, in particular those modified polyisocyanates which are derived from 4,4′- and/or 2,4′-diphenylmethane diisocyanate, may be used concomitantly. The modified toluene diisocyanate II)a) that is used preferably has an NCO content of less than 44 wt. %, more preferably less than 42 wt. %, most preferably less than 40 wt. %, relative to the modified toluene diisocyanate II)a).

The process of the present invention is advantageous if the polyisocyanate composition II that is used is made up of from 95 to 100 wt. %, relative to the total quantity of the polyisocyanate composition II, of a modified toluene diisocyanate IIa) with an NCO content of less than 44 wt. %.

The process of the present invention is advantageous if the modified toluene diisocyanate with an NCO content less than 44 wt. %, relative to the modified toluoylene diisocyanate IIa), which is used is obtained by modification of a mixture of from 65 to 100 wt. %, relative to the total weight of the modified toluene diisocyanate II)a), 2,4-toluene diisocyanate and from 0 to 35 wt. %, relative to the total quantity of the modified toluene diisocyanate II)a), 2,6-toluene diisocyanate with a component containing at least two groups that are reactive with isocyanates.

For the purpose of producing polyurethane foamed materials, water (component III)) is employed as a chemical blowing agent, which by virtue of reaction with isocyanate groups yields carbon dioxide which acts as a blowing gas. Water is preferably employed in a quantity from 6 parts by weight to 40 parts by weight, more preferably from 8 parts by weight to 20 parts by weight, relative to the sum of the quantities of components I)a), I)b), I)c) and I)d).

Component IV) may be one or more non-combustible physical blowing agents such as carbon dioxide, particularly in liquid form. In principle, other suitable blowing agents include: hydrocarbons such as C₃-C₆ alkanes, for example butanes, n-pentane, isopentane, cyclopentane, hexanes and the like; and halogenated hydrocarbons such as dichloromethane, dichloromonofluoromethane, chlorodifluoroethanes, 1,1-dichloro-2,2,2-trifluoroethane, 2,2-dichloro-2-fluoroethane, in particular chlorine-free fluorohydrocarbons such as difluoromethane, trifluoromethane, difluoroethane, 1,1,1,2-tetrafluoroethane, tetrafluoroethane (R134 or R134a), 1,1,1,3,3-pentafluoropropane (R245fa), 1,1,1,3,3,3-hexafluoropropane (R256), 1,1,1,3,3-pentafluorobutane (R365mfc), heptafluoropropane or even sulfur hexafluoride. Mixtures of these blowing agents may also be used.

One or more catalysts for the blowing and crosslinking reaction may be included in the polyol composition as component V). Examples of suitable catalysts include tertiary amines, such as N,N′-dimethylaminoethanol, triethylamine, tributylamine, N-methylmorpholine, N-ethylmorpholine, N,N,N′,N′-tetramethylethylenediamine, pentamethyldiethylenetriamine and higher homologues (DE-A 26 24 527 and DE 26 24 528), 1,4-diazabicyclo[2,2,2]octane, N-methyl-N′-dimethylaminoethylpiperazine, bis(dimethylaminoalkyl)piperazine, N,N-dimethylbenzylamine, N,N-dimethylcyclohexylamine, N,N-diethylbenzyl-amine, bis(N,N-diethylaminoethyl)adipate, N,N,N′,N′-tetramethyl-1,3-butane-diamine, N,N-dimethyl-β-phenylethylamine, 1,2-dimethylimidazole, 2-methyl-imidazole, monocyclic and bicyclic amidines and also bis(dialkylamino)alkyl ethers such as 2,2-bis(dimethylaminoethyl)ether.

Examples of flameproofing agents suitable for use as component VI) are phosphorus compounds such as the esters of phosphoric acid, phosphonic acid and/or of phosphorous acid with halogenated or non-halogenated alcohol components, for example triphenyl phosphate, tricresyl phosphate, tributyl phosphate, tris(2-chlorisopropyl)phosphate, tris(2,3-dichlorisopropyl phosphate), expanded graphite and combinations thereof.

Examples of materials useful as components VII) and VIII) which are optionally used include: foam stabilizers, cell regulators, reaction retarders, stabilizers for countering discolorations and oxidations, plasticizers, dyestuffs and fillers and also substances that are fungistatically and bacteriostatically active. These are generally added to the polyol component in quantities of from 0 parts by weight to 30 parts by weight, preferably from 2 parts by weight to 10 parts by weight, relative to the polyol composition I. Particulars concerning the manner of use and mode of action of these materials are described in G. Oertel (ed.): Kunststoff-Handbuch, Volume VII, Carl Hanser Verlag, 3^{rd} Edition, Munich 1993, pages 110-115.

For the purpose of producing the polyurethane foamed materials of the present invention, the reaction components are caused to react, in accordance with the invention, by a single-stage process known as such, by the prepolymer process or the semiprepolymer process. Suitable apparatus for producing foams by these processes are described in U.S. Pat. No. 2,764,565. Particulars concerning processing devices that also enter into consideration in accordance with the invention are described in Kunststoff-Handbuch, Volume VII, edited by Wieweg and Höchtlen, Carl Hanser Verlag, Munich 1966, for example on pages 121 to 205.

In the course of production of foamed material in accordance with the present invention, the foaming may also be carried out in closed molds. In this case, the reaction mixture is charged into a mold. Suitable molds may be produced from metal, e.g., aluminum or from plastic, e.g., epoxy resin.

In the mold, the foamable reaction mixture foams up and forms the molded article. The foaming in the mold may in this case be carried out in such a way that the molded article exhibits a cell structure on its surface. But it may also be carried out in such a way that the molded article is given a compact skin and a cellular core. In accordance with the invention, the procedure may also be such that foamable reaction mixture is charged into the mold in an amount such that the foamed material which is formed just fills the mold.

But it is possible to introduce more foamable reaction mixture into the mold than is necessary for the purpose of filling the mold with foamed material. In the latter case, working consequently proceeds subject to overcharging. Such a procedure is described in U.S. Pat. No. 3,178,490 and U.S. Pat. No. 3,182,104, for example.

In the course of foaming the molded article, in many cases “external mold-release agents” such as silicone oils, are used. But any of the so-called “internal mold-release agents”, optionally in a mixture with external mold-release agents, such as those disclosed in DE-OS 2 121 670 and DE-OS 2 307 589 may also be used.

The foamed materials produced in accordance with the present invention are preferably produced by block foaming.

The polyurethane foams obtained by the process of the present invention are preferably used for acoustic and thermal insulation applications, for example, in motor vehicles and construction applications.

Having thus described the invention, the following Examples are given as being illustrative thereof.

### EXAMPLES

The materials listed below were used to produce polyurethane foamed materials by the known single-stage process in the Examples which follow.
Polyol 1 trifunctional polyether polyol, prepared by potassium-hydroxide-catalyzed alkoxylation of glycerin with a mixture of propylene oxide and ethylene oxide in a quantitative ratio of 89/11, with an OH value of 48 mg KOH/g and with a proportion of secondary hydroxyl terminal groups amounting to 94%.
Polyol 2 trifunctional polyether polyol, prepared by potassium-hydroxide-catalyzed alkoxylation of glycerin with propylene oxide, with an OH value of 56 mg KOH/g and with a proportion of secondary hydroxyl terminal groups amounting to 96%.
Polyol 3 trifunctional polyether polyol, prepared by DMC-catalyzed alkoxylation of glycerin with a mixture of propylene oxide and ethylene oxide in a quantitative ratio of 89/11, with an OH value of 48 mg KOH/g and with a proportion of secondary hydroxyl terminal groups amounting to 89%.
Polyol 4 trifunctional polyether polyol, prepared by potassium-hydroxide-catalyzed alkoxylation of glycerin with propylene oxide (87%) and subsequently with ethylene oxide (13%), with an OH value of 28 mg KOH/g and with a proportion of secondary hydroxyl terminal groups amounting to 21%.
Polyol 5 a polyester polyol based on trimethylolpropane, diethylene glycol and adipic acid with an OH value of 60 mg KOH/g which is commercially available under the name Desmophen® 2200 B from Bayer MaterialScience AG, Leverkusen.
Niax® Silicone L-620: a polyether-siloxane-based foam stabilizer which is commercially available from GE Speciality Chemicals.
Niax® Catalyst A 1: bis[2-dimethylamino)ethyl]ether in dipropylene glycol which is commercially available from GE Speciality Chemicals.
Niax® Catalyst DMEA: dimethylaminoethanol which is commercially available from GE Speciality Chemicals.
Addocat® SO: tin 2-ethylhexanoate which is commercially available from Rheinchemie, Mannheim.
Isocyanate 1: mixture of 2,4- and 2,6-TDI (80:20) with an NCO content of 48 wt. %.
Isocyanate 2: biuret-modified mixture of 2,4- and 2,6-TDI (80:20) with an NCO content of 37 wt. %.
Isocyanate 3: polymeric MDI with an NCO content of 31.5 wt. %.

### Example 1

| | | |
|---|---|---|
| Polyol 3 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 188 | parts by weight |
| NCO/OH Index | 72 | |
| Bulk density | 10.7 | kg/m³ |
| Compressive strength (40% comp.) | 5.2 | kPa |
| Tensile strength | 75 | kPa |

| | |
|---|---|
| Elongation at break | 27% |

### Example 2

| | | |
|---|---|---|
| Polyol 3 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 141 | parts by weight |
| Isocyanate 3 | 54.6 | parts by weight |
| NCO/OH Index | 72 | |
| Bulk density | 10.8 | kg/m³ |
| Compressive strength (40% comp.) | 5.2 | kPa |
| Tensile strength | 59 | kPa |

| | |
|---|---|
| Elongation at break | 22% |

### Example 3

| | | |
|---|---|---|
| Polyol 3 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 94 | parts by weight |
| Isocyanate 3 | 109.9 | parts by weight |
| NCO/OH Index | 72 | |
| Bulk density | 11.3 | kg/m³ |
| Compressive strength (40% comp.) | 7.0 | kPa |
| Tensile strength | 72 | kPa |

| | |
|---|---|
| Elongation at break | 23% |

### Example 4

| | | |
|---|---|---|
| Polyol 3 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 47 | parts by weight |
| Isocyanate 3 | 164.9 | parts by weight |
| NCO/OH Index | 72 | |
| Bulk density | 11.9 | kg/m³ |
| Compressive strength (40% comp.) | 7.9 | kPa |
| Tensile strength | 66 | kPa |

| | |
|---|---|
| Elongation at break | 16% |

### Comparative Example 1

| | | |
|---|---|---|
| Polyol 3 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 3 | 219.8 | parts by weight |
| NCO/OH Index | 72 | |
| Bulk density | 13.2 | kg/m³ |
| Compressive strength (40% comp.) | 8.4 | kPa |
| Tensile strength | 48 | kPa |

| | |
|---|---|
| Elongation at break | 8% |

### Comparative Example 2

| | | |
|---|---|---|
| Polyol 4 | 100 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 188 | parts by weight |
| NCO/OH Index | 72 | |

The foamed material had no measurable physical properties, because it collapsed in the course of the production test.

### Example 5

| | | |
|---|---|---|
| Polyol 2 | 80 | parts by weight |
| Polyol 5 | 20 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 2 | 170.8 | parts by weight |
| NCO/OH Index | 65 | |
| Bulk density | 9.7 | kg/m³ |
| Compressive strength (40% comp.) | 7.9 | kPa |
| Tensile strength | 66 | kPa |

| | |
|---|---|
| Elongation at break | 16% |

### Comparative Example 3

| | | |
|---|---|---|
| Polyol 2 | 80 | parts by weight |
| Polyol 3 | 20 | parts by weight |
| Niax ® Catalyst DMEA | 0.20 | parts by weight |
| Niax ® Catalyst A1 | 0.20 | parts by weight |
| Niax ® Silicone L-620 | 2.50 | parts by weight |
| Addocat ® SO | 0.1 | parts by weight |
| Water | 20.0 | parts by weight |
| Isocyanate 3 | 219.8 | parts by weight |
| NCO/OH Index | 72 | |
| Bulk density | 13.2 | kg/m³ |
| Compressive strength (40% comp.) | 8.4 | kPa |
| Tensile strength | 48 | kPa |

| | |
|---|---|
| Elongation at break | 8% |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a polyurethane foamed material having a bulk density of less than 25 kg m⁻³ comprising reacting
I) a polyol composition comprising:
a) 30-100 wt. %, relative to total weight of the polyol composition, of a polyoxyalkylene polyether polyol with
(i) a nominal functionality of from 2 to 4,
(ii) an average molar mass of from 1500 to 6000,
(iii) more than 35% of secondary hydroxyl terminal groups, relative to total number of hydroxyl terminal groups of the polyalkylene polyether polyol,
b) 0-50 wt. %, relative to total weight of the polyol composition, of a polyoxyalkylene polyether polyol with
(i) a nominal functionality of from 2 to 3.5, and
(ii) an average molar mass of from 400 to 1000,
c) 0-50 wt. %, relative to total weight of the polyol composition, of a polyoxyalkylene polyether polyol with
(i) a nominal functionality of from 4 to 8, and
(ii) an average molar mass of from 300 to 1000,
d) 0-30 wt. %, relative to total amount of the polyol composition, of a polyester polyol with
(i) a hydroxyl value of from 40 to 500
with
II) a polyisocyanate composition with an isocyanate content of from 31 to 43 wt. %, relative to total quantity of the polyisocyanate composition, in a quantity corresponding to an NCO/OH index of from 25-150, which polyisocyanate composition comprises:
a) 20-100 wt. %, relative to total weight of the polyisocyanate composition, of a modified toluene diisocyanate with an NCO content less than 44 wt. %, and
b) 0-80 wt. %, relative to total amount of the polyisocyanate composition, of one or more MDI products,
III) 6-40 parts by weight of water, relative to total weight of the polyol composition,
IV) optionally, one or more physical blowing agents,
V) one or more catalysts,
VI) one or more flameproofing agents,
VII) one or more stabilizers, and
VIII) optionally, one or more auxiliary substances and/or additives which are not in any of groups III), IV), V), VI) or VII).

2. The process of claim 1 in which the NCO/OH index is within the range 35-120.

3. The process of claim 1 in which the polyisocyanate composition II has an isocyanate content of from 35 to 39 wt. %, relative to total polyisocyanate composition.

4. The process of claim 1 in which the polyisocyanate composition comprises:
a) 50-100 wt. %, relative to total weight of the polyisocyanate composition, of a modified toluene diisocyanate with an NCO content less than 44 wt. %, relative to modified toluene diisocyanate, and
b) 0-50 wt. %, relative to total weight of the polyisocyanate composition, of an MDI product.

5. The process of claim 1 in which the polyisocyanate composition comprises 95-100 wt. %, relative to total weight of the polyisocyanate composition, of a modified toluene diisocyanate with an NCO content less than 44 wt. %.

6. The process of claim 1 in which the modified toluene diisocyanate is obtained by modification of a mixture of 65-100 wt. %, relative to the total weight of toluene diisocyanate, 2,4-toluene diisocyanate with 0-35 w. %, relative to the total weight of toluene diisocyanate, 2,6-toluene diisocyanate with a material having at least two isocyanate-reactive groups.

7. A polyurethane foam produced by the process of claim 1.

8. Acoustic and/or thermal insulation produced from the foam of claim 7.
